(19) United States
(12) Patent Application Publication
(10) Pub. No.: US 2009/0252866 A1
(43) Pub. Date: Oct. 8, 2009

(54) METHOD OF PRODUCING GLASS FORMING MOLD

(75) Inventor: Jun Masuda, Mishima-Shi (JP)

Correspondence Address: DLA PIPER LLP US, P. O. BOX 2758, RESTON, VA, 20195, US

(73) Assignee: TOSHIBA KIKAI KABUSHIKI KAISHA, Tokyo (JP)

(21) Appl. No.: 12/482,497

(22) Filed: Jun. 11, 2009

Related U.S. Application Data
(63) Continuation of application No. PCT/JP2007/073956, filed on Dec. 12, 2007.

(30) Foreign Application Priority Data
Dec. 14, 2006 (JP) 2006-337146

(51) Int. Cl. B28B 7/38; C21D 1/00; B05D 7/22

(52) U.S. Cl. 427/135; 148/527

(57) ABSTRACT

A steel base material is hardened to produce the base material having a martensite structure, a surface coating layer made of an amorphous Ni—P alloy is formed on the surface of the base material, and the base material is heat-treated to transform the structure of the base material into a troostite structure or a sorbite structure and also to transform the structure of the surface coating layer into an eutectic structure of Ni and Ni₃P. This prevents the surface coating layer from producing cracks at the molding temperature and prevents the plastic deformation of the mold, thereby maintaining the shape of the mold with high accuracy.

### CROSS-REFERENCE TO RELATED APPLICATIONS

This is a Continuation Application of PCT Application No. PCT/JP2007/073956, filed Dec. 12, 2007, which was published under PCT Article 21(2) in Japanese.

This application is based upon and claims the benefit of priority from prior Japanese Patent Application No. 2006-337146, filed Dec. 14, 2006, the entire contents of which are incorporated herein by reference.

### BACKGROUND OF THE INVENTION

1. Field of the Invention

The present invention relates to a method of producing a glass forming mold for which precision processing is required and, particularly, to a method enabling the mold to maintain its shape with high accuracy.

2. Description of the Related Art

Precision processing technologies of a forming mold are established in the fields of plastic molding, and mass-production of optical elements having a fine shape such as a diffraction grating has been realized. In this case, the mold is produced by treating the surface of a base material made of stainless steel by electroless Ni—P plating and by precisely processing the surface coating layer with a diamond bite.

### BRIEF SUMMARY OF THE INVENTION

However, when a similar mold is applied to glass molding, this gives rise to the problem that cracks are produced on an electroless Ni—P surface coating layer. This phenomenon is caused by molding temperature. Specifically, though the Ni—P surface coating layer has an amorphous structure in a plated state, it starts crystallizing when heated to about 270° C. or more, and at this time, the volumetric shrinkage of the surface coating layer is caused, so that a tensile stress acts on the surface coating layer, producing cracks.

To deal with this problem, a base material having a thermal expansion coefficient of 10×10⁻⁶ to 16×10⁻⁶ (K⁻¹) is selected, plated and heat-treated at 400 to 500° C. However, even if the thermal expansion coefficient of the base material is matched with that of the Ni—P surface coating layer, only the surface coating layer volumetrically shrinks along with crystallization in the heat treatment, a large tensile stress acts on the surface coating layer and there is therefore the case where cracks are generated (see, for example, Jpn. Pat. Appln. KOKAI Publication No. 11-157852).

In light of this, it is an object of the present invention to provide a method of producing a glass forming mold that can prevent the generation of cracks on the surface coating layer at the molding temperature.

In order to solve the above problem, thereby attaining the object, a method of producing a glass forming mold according to the present invention has the following structure.

Hardening a steel base material to produce the base material having a martensite structure; forming a surface coating layer made of an amorphous Ni—P alloy on a surface of the base material; and heat-treating the base material to transform a structure of the base material into a troostite structure or a sorbite structure and also to transform a structure of the surface coating layer into an eutectic structure of Ni and Ni₃P.

Hardening a steel base material and then by carrying out subzero treatment to produce the base material having a martensite structure; forming a surface coating layer made of an amorphous Ni—P alloy on a surface of the base material; and heat-treating the base material to transform a structure of the base material into a troostite structure or a sorbite structure and also to transform a structure of the surface coating layer into an eutectic structure of Ni and Ni₃P.

Hardening a steel base material, then by carrying out subzero treatment, and further by tempering to produce the base material having a structure in which ε-carbide is dispersed in martensite; forming a surface coating layer made of an amorphous Ni—P alloy on a surface of the base material; and heat-treating the base material to transform a structure of the base material into a troostite structure or a sorbite structure and also to transform a structure of the surface coating layer into an eutectic structure of Ni and Ni₃P.

### BRIEF DESCRIPTION OF THE SEVERAL VIEWS OF THE DRAWING

FIG. 1 is a block diagram showing the outline of a method of producing a glass forming mold according to an embodiment of the present invention.

### DETAILED DESCRIPTION OF THE INVENTION

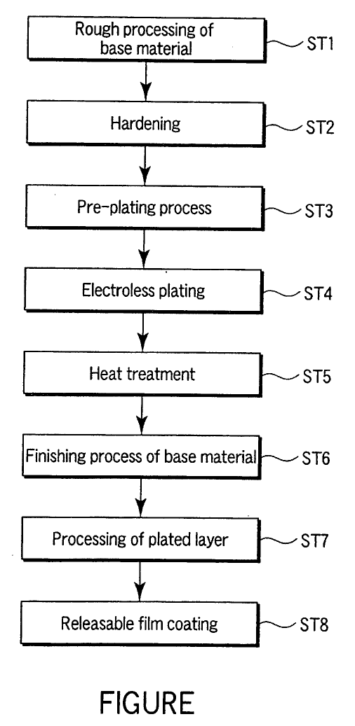

FIG. 1 is a block diagram showing the outline of a method of producing a glass forming mold according to an embodiment of the present invention. A glass forming mold is produced in the following steps.

In this case, a steel raw material containing 0.3 wt % or more and 2.7 wt % or less of carbon and 13 wt % or less of chromium is used as the base material.

After such a base material is subjected to roughing treatment (ST1), it is hardened (ST2). Then, the hardened base material is subjected to a pre-plating process (ST3), and then, a surface coating layer (plated layer) made of a Ni—P alloy is formed on the surface of the base material by electroless plating (ST4). Then, the base material and the surface coating layer are heat-treated (ST5) to crystallize the surface coating layer and also to transform the structure of the base material into a temper structure. Then, the finish processing of the base material (ST6) and the finish processing of the surface coating layer (ST7) are performed and then, the surface coating layer is coated with a releasing film (ST8).

In this embodiment, in the heat treatment process for crystallizing the surface coating layer, the variation in the dimension of the base material of the mold is made close to the variation in the dimension of the surface coating layer to thereby limit the tensile stress acting on the surface coating layer to a small level, thereby preventing the generation of cracks.

Here, the process of the heat treatment will be explained by dividing the process into three stages (first to three stages). Table 1 shows the temperature variation, structural variation and dimensional variation of the base material in the first to third stages.

TABLE 1
Effects of tempering of carbon steel:
changes in structure and length

| | Temperature | | Dimensional |
|---|---|---|---|
| | range | Structural variation | variation |
| First | 100~200° C. | Martensite → low-carbon | Shrink |
| stage | | martensite + ε-carbide | |
| Second | 230~270° C. | Retained austenite → bainite | Expand |
| stage | | | |
| Third | 270~430° C. | Low-carbon martensite → ferrite + | Shrink |
| stage | | cementite ε-carbide → cementite | |

Specifically, the volume of the base material shrinks with the variation of the structure in the first stage. Also, the base material is expanded in the second stage. Because a variation in volume in these first and second stages is very small, no crack is produced on the surface coating layer.

In the third stage, on the other hand, cementite is precipitated from a low-carbon martensite while the base material is heated from about 270° C. to 430° C., and the structure of the mother material is changed to ferrite, leading to the shrinkage of the volume. At this time, the amorphous Ni—P alloy layer formed on the surface of the mold by electroless plating is transformed into an eutectic structure of Ni and Ni₃P, leading to shrinkage of the volume when the mold is heated to the molding temperature of the glass. Since such a volumetric shrinkage starts at about 270° C., no tensile stress is produced and no crack is produced on the surface coating layer.

The heat treating temperature is designed to be more than the working temperature of the mold. When the heating temperature is less than the working temperature, a dimensional variation is caused, leading to less dimensional accuracy of the molded article. However, the upper limit of the heat treating temperature is preferably higher than the working temperature of the mold by about 30° C. If the heat treating temperature is made higher than required, this exerts such an adverse effect as to soften the base material.

With regard to the composition of the base material, the content of C is preferably 0.3 wt % or more and 2.7 wt % or less. When the content of C is less than 0.3 wt %, the amount of the volumetric shrinkage of the base material in the third stage of the tempering is too small. On the other hand, when the content of C exceeds 2.7 wt %, this gives rise to disorders such as a reduction in toughness though the volumetric shrinkage of the base material is sufficient.

Also, the content of Cr is preferably 13 wt % or less. When the content of Cr exceeds 13 wt %, the retained austenite in the second stage becomes decomposed at 500° C. or more, which entails mismatching of the base material with the Ni—P surface coating layer in volumetric shrinkage. In this case, there is no particular restriction on the lower limit of the content of Cr.

It is necessary that the base material prior to the heat treatment has a martensite structure (or low-carbon martensite+ε-carbide). When this martensite is decomposed into ferrite and cementite, large volumetric shrinkage occurs. The base material after the heat treatment resultantly has a troostite structure (structure in which ferrite and cementite are mixed very finely) or a sorbite structure (ferrite-cementite mixed structure in which cementite is granularly precipitated and grown).

The structure of the Ni—P or Ni—P—B surface coating layer is amorphous or partially amorphous in a plated state, and is transformed into a completely crystallized Ni and Ni₃P mixed structure when heated to about 270° C. or more. The above metallographic characteristics are summarized in Table 2.

TABLE 2
Structures of the base material and surface
layer before and after the heat treatment

| | Before heat treatment | After heat treatment |
|---|---|---|
| Base | Martensite | Troostite |
| material | Martensite + ε-carbide | Sorbite |
| Surface | Amorphous Ni | Crystalline Ni + Ni₃P |
| layer | | |

Molds were produced by coating base materials having various compositions respectively with electroless Ni—P plating 100 μm in thickness to examine the number of cracks generated during heat treatment and molding. The relation between the composition of the base material, subzero temperature, tempering temperature and heat treating condition, and the ratio of generation of cracks is shown in Table 3. The molding temperatures of the glass were all set to 430° C.

TABLE 3
Relation between the components of the base material and tempering
and heat treating conditions and the ratio of generation of cracks

| Base | Content | Content | Subzero | Tempering | Heat treating | Ratio of generation |
|---|---|---|---|---|---|---|
| material | of C | of Cr | temperature | temperature | temperature | of cracks |
| Sample 1 | 0.7 | 0.9 | None | None | 450° C. | 0/5 |
| Sample 2 | 0.7 | 0.9 | None | 370° C. | 450° C. | 3/5 |
| Sample 3 | 1.2 | 1.0 | −80° C. | None | 450° C. | 0/5 |
| Sample 4 | 1.2 | 1.0 | −80° C. | 250° C. | 450° C. | 0/5 |
| Sample 5 | 0.1 | 13.8 | None | None | 450° C. | 5/5 |
| Sample 6 | 0.1 | 13.8 | −80° C. | None | 450° C. | 4/5 |

As mentioned above, the method of producing a glass forming mold according to this embodiment can prevent the surface coating layer from generating cracks in the heat treatment of the sample 1 and can also prevent the plastic deformation of the mold, thereby maintaining the shape of the mold with high accuracy.

In this case, the subzero treatment may be performed after the hardening treatment as shown by the case of the sample 3. Retained austenite existing in the base material after the hardening treatment can be transformed into martensite by the subzero treatment. This is why the volumetric shrinkage in the third stage due to the decomposition of martensite (low-carbon martensite) arises more significantly.

Moreover, as shown by the case of the sample 4, the following tempering treatment performed at 350° C. or less can be carried out after the hardening and subzero treatments. When the tempering temperature is higher than 350° C., the volumetric shrinkage of the base material in the third stage is insufficient and there is the case where cracks are produced on the surface coating layer.

The present invention is not limited to the above embodiment. For example, the heat treatment of the base material and surface coating layer may be carried out after the finishing processing of the base material and the finishing processing of the surface coating layer. It is needless to say that the present invention can be variously modified without departing from the spirit of the present invention.

According to the present invention, the generation of cracks on the surface coating layer at the molding temperature can be prevented.

What is claimed is:

1. A method of producing a glass forming mold, comprising:
hardening a steel base material to produce the base material having a martensite structure;
forming a surface coating layer made of an amorphous Ni—P alloy on a surface of the base material; and
heat-treating the base material to transform a structure of the base material into a troostite structure or a sorbite structure and also to transform a structure of the surface coating layer into an eutectic structure of Ni and Ni₃P.

2. The method of producing a glass forming mold according to claim 1, wherein carbon contained in the base material is 0.3 wt % or more and 2.7 wt % or less and chromium contained in the base material is 13 wt % or less.

3. The method of producing a glass forming mold according to claim 2, wherein the surface coating layer is formed by electroless plating containing Ni and P, Ni, P and B or Ni, P and W, and
the heat treatment is carried out at a higher temperature than a working temperature of the mold.

4. The method of producing a glass forming mold according to claim 3, wherein the heat treatment is carried out at 270° C. or more.

5. A method of producing a glass forming mold, comprising:
hardening a steel base material and then by carrying out subzero treatment to produce the base material having a martensite structure;
forming a surface coating layer made of an amorphous Ni—P alloy on a surface of the base material; and
heat-treating the base material to transform a structure of the base material into a troostite structure or a sorbite structure and also to transform a structure of the surface coating layer into an eutectic structure of Ni and Ni₃P.

6. The method of producing a glass forming mold according to claim 5, wherein carbon contained in the base material is 0.3 wt % or more and 2.7 wt % or less and chromium contained in the base material is 13 wt % or less.

7. The method of producing a glass forming mold according to claim 6, wherein the surface coating layer is formed by electroless plating containing Ni and P, Ni, P and B or Ni, P and W, and
the heat treatment is carried out at a higher temperature than a working temperature of the mold.

8. The method of producing a glass forming mold according to claim 7, wherein the heat treatment is carried out at 270° C. or more.

9. A method of producing a glass forming mold, comprising:
hardening a steel base material, then by carrying out subzero treatment, and further by tempering to produce the base material having a structure in which ε-carbide is dispersed in martensite;
forming a surface coating layer made of an amorphous Ni—P alloy on a surface of the base material; and
heat-treating the base material to transform a structure of the base material into a troostite structure or a sorbite structure and also to transform a structure of the surface coating layer into an eutectic structure of Ni and Ni₃P.

10. The method of producing a glass forming mold according to claim 9, wherein carbon contained in the base material is 0.3 wt % or more and 2.7 wt % or less and chromium contained in the base material is 13 wt % or less.

11. The method of producing a glass forming mold according to claim 10, wherein a tempering temperature of the base material is 350° C. or less.

12. The method of producing a glass forming mold according to claim 10, wherein the surface coating layer is formed by electroless plating containing Ni and P, Ni, P and B or Ni, P and W, and
the heat treatment is carried out at a higher temperature than a working temperature of the mold.

13. The method of producing a glass forming mold according to claim 12, wherein the heat treatment is carried out at 270° C. or more.
